(19) United States
(12) Patent Application Publication
(10) Pub. No.: US 2023/0150080 A1
(43) Pub. Date: May 18, 2023

(54) METHOD FOR ESTIMATING TOOL LIFE IN A CUTTING MACHINE

(71) Applicant: NATIONAL CHENG KUNG UNIVERSITY, Tainan City (TW)

(72) Inventor: YEAU-REN JENG, TAINAN CITY (TW)

(21) Appl. No.: 17/552,920

(22) Filed: Dec. 16, 2021

(30) Foreign Application Priority Data
Nov. 17, 2021 (TW) 110142799

(51) Int. Cl. B23Q 17/09; B23Q 17/20

(52) U.S. Cl. CPC B23Q 17/0995; B23Q 17/0966; B23Q 17/20

(57) ABSTRACT

The disclosure provides a method to estimate tool life on a cutting machine. A sensor is installed on the cutting machine to measure the cutting thrust of a cutting tool during operation. Specifically, the information gathered from the sensor enables the cutting tool to cut a workpiece at different settings of cutting rate, with a maximum cutting thrust of the cutting tool measured during each cut, and defined as a characteristic signal. Through the characteristic signals obtained from the multiple cuts, factorization processing and inverse processing are initiated to obtain plural values in a complex remaining life index for the cutting tool. Using the cutting rate as the horizontal axis and the remaining life as the vertical axis, the complex remaining life and corresponding cutting rates are plotted on the vertical axis and the horizontal axis to form a line graph illustrating the complex remaining life index.

### FIELD OF THE DISCLOSURE

The present disclosure relates to one or more cutting tools installed in a cutting machine, and in particular to a method of individualized estimation of tool life in the cutting machine.

### BACKGROUND OF THE DISCLOSURE

Generally, an operator would use his/her experience to operate various cutting tools installed in the cutting machine in order to cut one or more workpieces. However, the tools used in the cutting machines will eventually be worn out after a period of time. Therefore, any evaluation on the life of the cutting tool installed on the cutting machine is mostly conducted based on the experience of a skilled operator by judging, e.g., the type and usage of the cutting tool, and/or material of the workpiece to be cut.

Currently, there are proposals to install multiple sensors on the cutting machine to collect data on the cutting process in order to construct a simulation model in order to derive the optimal result of cutting. However, there is no effective or specific technology to evaluate tool life. In addition, it has been proposed to install multiple sensors on each system of the cutting machine to warn against improper operation and to avoid machining under adverse production conditions. Still, the aforementioned proposals do not have a specific and valid assessment capability for the tool life, and lack any tool life assessment technique with any reference value. In addition, the aforementioned proposals require the installation of a large number of sensors, so the overall cost, including the cost of sensors, installation costs and computer systems, is high and not conducive to the industrial use.

Indeed, there is no known technology related to evaluating the tool life, much less any technology for effective evaluation of the tool life in the cutting machine as provided by the present disclosure.

### SUMMARY OF THE DISCLOSURE

It is therefore an object of the present disclosure to disclose an individualized tool life estimation method for cutting machines, which can specifically and effectively provide the evaluation results for the remaining life of the cutting tool.

In order to achieve the above object, the present disclosure provides a method for estimating the tool life of an individualized cutting machine, comprising the steps as discussed below. Setting up in step A by installing at least one force sensor on the cutting machine, which senses the cutting thrust of the tool of the cutting machine when a workpiece is cut. Establishing basic data in step B by setting several different cutting rate settings for the cutting machine, operating the cutting machine to cut the workpiece with the tool according to each of the cutting rate settings, and recording after each cut the type of the tool, the material of the workpiece, and the length of the workpiece being cut. Numerical processing in step C by factorizing and counting down characteristic signal corresponding to each cut in step to obtain the complex value, which is defined as the complex remaining life index of the tool on the workpiece. Graphical processing in step D by using the cutting rate as the horizontal axis, with the higher value of the cutting rate going to the right, and using the remaining life index as the vertical axis, with the greater value going up. The remaining life indicators and their corresponding cutting rates in step C are drawn and connected via a line graph according to the values of the vertical axis and the horizontal axis.

From the above steps, the present disclosure provides a specific and effective method to evaluate the remaining life of the cutting tool for the user's reference, thereby solving the problem in the conventional technology, which cannot evaluate tool life.

### BRIEF DESCRIPTION OF THE DRAWINGS

Additional features and advantage of the present disclosure will be made apparent from the following detailed description of one or more exemplary embodiments with reference to the accompanying figures, which are given for illustrative purpose only, and thus are not limitative of the present disclosure, wherein:

FIG. 1 is a flowchart according to an exemplary embodiment of the present disclosure;

FIG. 2 is a schematic illustration showing the structure of the exemplary of the present disclosure;

FIG. 3 is a chart showing the life estimation line of the exemplary embodiment of the present disclosure.

FIG. 4 is a chart showing another life estimation line of the exemplary embodiment of the present disclosure; and

FIG. 5 is a chart showing a further life estimation line diagram of the exemplary embodiment of the present disclosure.

### DETAILED DESCRIPTION OF THE EXEMPLARY EMBODIMENT

An exemplary embodiment according to the present disclosure will be described below with references to the accompanying figures. It should be understood that the figures are not depicted to scale.

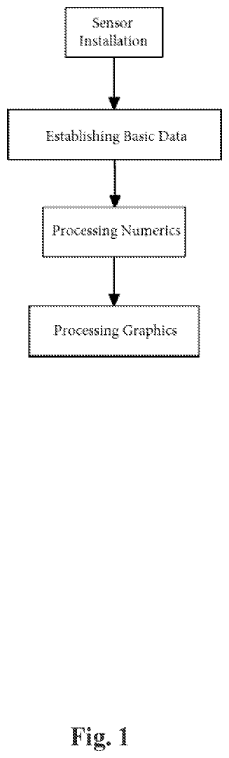

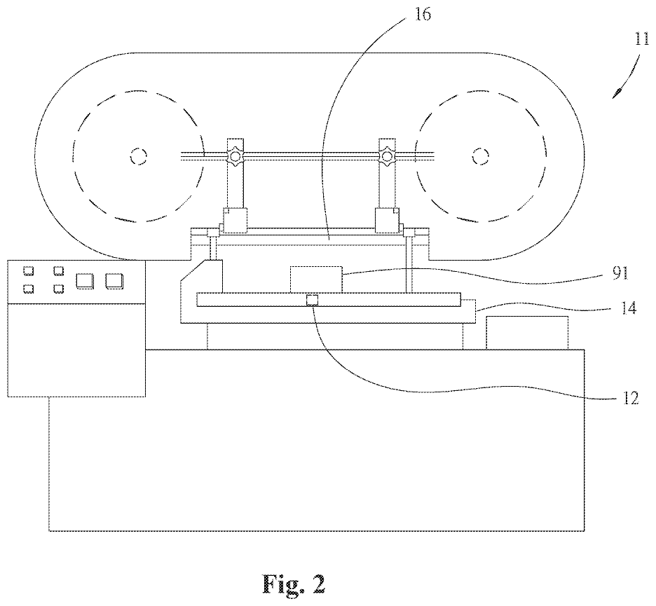

Referring to FIGS. 1 to 3, one of the exemplary embodiments of the present disclosure provides a method for estimating tool life of an individualized cutting machine, having steps as discussed below.

Step A involves sensor installation on a cutting machine 11. Specifically, a force sensor 12 is installed on the cutting machine 11. The cutting machine 11 has a feed seat 14 and a cutting tool 16. A band saw is used as the cutting tool 16 in the exemplary embodiment. The force sensor 12 is mounted on the feed seat 14, and a workpiece 91 is placed on the feed seat 14. The cutting force of the cutting tool 16 acting on the workpiece 91 can be measured when the workpiece 91 is fed to the tool 16 by the feed seat 14 and cut accordingly. By mounting the force sensor 12 on the feed seat 14 and placing the workpiece 91 on the feed seat 14, the cutting thrust of the cutting tool 16 on the workpiece 91 can be measured when the workpiece 91 is cut by feeding the workpiece 91 to the cutting tool 16 through the feed seat 14. In the exemplary embodiment, the force sensor 12 is mounted on the feed seat 14 only as an example since the force sensor 12 may also be mounted on, for instance, a cutting tool holder mounted in the cutting machine 11 for holding the cutting tool 16. In addition, the material of the workpiece 91 depends on the user preferences or needs. For instance, carbon steel S45C, tool steel SKD61, and stainless steel SUS304 are common metal workpiece materials in the industry.

Step B involves establishing basic data. Different cutting rate settings are provided to operate the cutting machine 11 that uses the tool 16 to cut the workpiece 91 according to each cutting rate setting. The force sensor 12 measures the cutting thrust of the cutting tool 16 during each aforementioned cut, and defines the maximum cutting thrust of the cutting tool 16 measured a characteristic signal during the cut. In addition, the type of the cutting tool 16, the material of the workpiece 91, and the length of the workpiece 91 are recorded during the cut. In the exemplary embodiment, the cutting rate is used as the setting reference, but such cutting rate can be replaced by the feeding rate. If the cutting rate is used as the setting reference, then the unit is used is the area/time, whereas if the feeding rate is used as the setting reference, then the unit is used is the length/time.

Step C involves numerical processing. The characteristic signal corresponding to each cut in the aforementioned step B is factorized (dimensionless processing) and counted down (reciprocal processing) to obtain a complex value, which is defined as the complex remaining life index RLI of the cutting tool 16 on the workpiece 91. The aforementioned dimensionless processing is performed using following equation (1): The characteristic signal/length of cut of the workpiece. For the reciprocal processing, the following equation (2) is used: 1/(the characteristic signal/the length of the workpiece being cut).

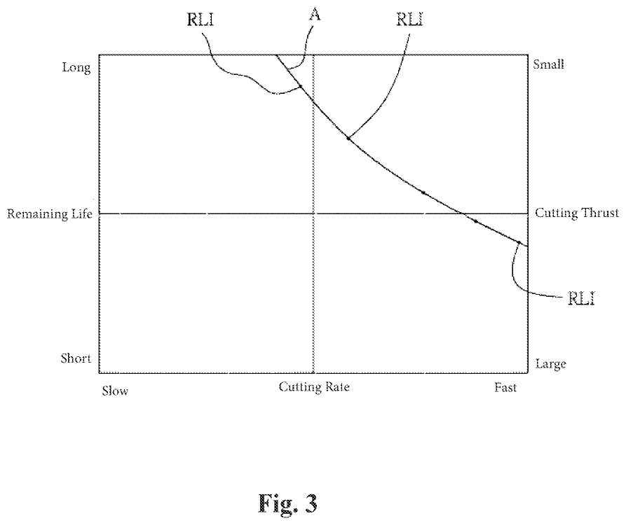

Step D involves graphical processing. As shown in FIG. 3, the cutting rate is reflected on the horizontal axis, with the faster cutting rate going rightward, and conversely, with the slower cutting rate going leftward. The remaining life and cutting thrust are reflected on the vertical axis, with the longer value of the remaining life and larger value of the cutting value going upward, and conversely, with the shorter value of the remaining life and larger value of the cutting thrust going downward. The aforementioned step C of the plural remaining life indicator RLI and its corresponding cutting rate according to the values of the vertical axis and the horizontal axis are plotted and connected to form a line graph in FIG. 3. As marked in the complex remaining life indicator as shown in FIG. 3, points corresponding to the values of RLI and their corresponding cutting rates are referenced as RLI, with line A in the line graph as the line formed by the remaining life index RLI of the tool 16 against the workpiece 91. Thus, the remaining life of the cutting tool 16 is estimated by the line graph in FIG. 3.

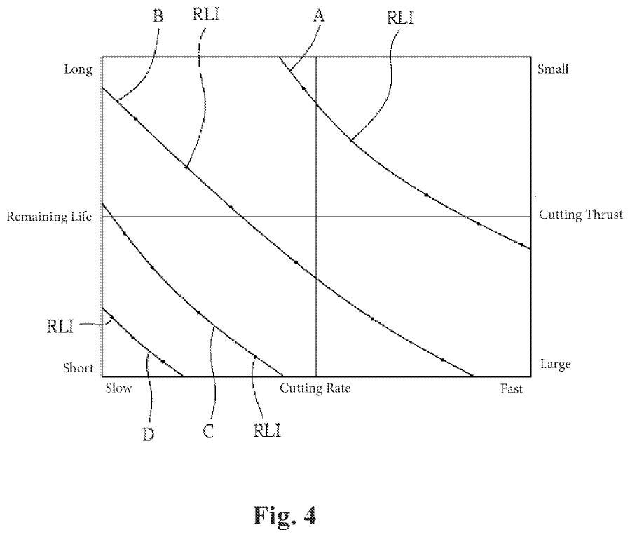

As shown in FIG. 4, the lines are presented for the same workpiece 91 and the same cutting tool 16 after the life estimation by the aforementioned method of the present disclosure under different wear and tear of the cutting tool 16, where lines A to D represent the lines connected by different remaining life indicators RLI from no wear and tear to severe wear and tear of the tool 16. In FIG. 4, the interpretation of line A is that even if the cutting rate is adjusted to the fastest, the remaining life index is still nearly half of the value, while the interpretation of lines B to D is that the bottom ends of lines B to D represent the shortest remaining life index at its corresponding cutting rate.

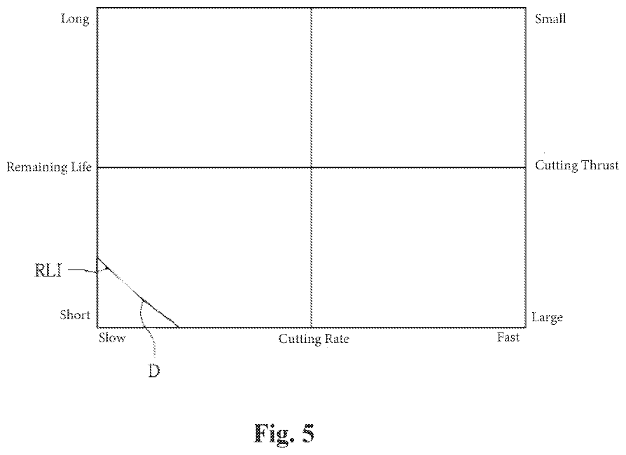

As shown in FIG. 5, if the cutting tool 16 is evaluated out to be the state of the line D, then if the cutting rate is adjusted to be faster than the cutting rate represented by the bottom end of the line D when the cutting tool 16 is used, then this cutting tool 16 may be damaged and cannot be used, so the user can set the cutting rate when the tool 16 is used with reference to the position of the bottom end of the line D so that it is not faster than the cutting rate represented by the bottom end of the line D. In this way, the user can ensure that the cutting tool 16 will not be damaged during use. It can be seen that the lines A to D can be used to understand the life evaluation basis of the cutting tool 16 in the current state, and the upper cutting rate of the cutting tool 16 can be known to the user, and then the cutting tool 16 can be used safely without causing damage to the cutting tool 16.

In the actual implementation of the above steps B to D, a computer (not shown) can be used to perform the relevant processing operations and to draw the line diagram, which is displayed on a display (not shown) connected to the computer. The computer and the display screen are known technologies and are not the technical focus of this case, so they will not be described.

To summarize, the present disclosure first establishes the basic data of the cutting tool 16 cutting on the workpiece 91, and then numerically processes and draws a chart for the user's reference to evaluate the remaining life of the cutting tool 16 cutting on the workpiece 91. Particularly, the individualized nature of the disclosure, i.e., in evaluating the tool life on the cutting machine, the evaluated value is only applicable to a particular tool on that cutting machine, but not applicable to any other tool of the same material on a different cutting machine. In other words, even if the cutting tools on different cutting machines are of the same material, they still need to be evaluated separately, i.e. the tools on different cutting machines need to be evaluated independently by the above-mentioned method of the present disclosure in order to evaluate the remaining life of the tool. As such, the individualized character of the present disclosure for the estimation of the tool on the cutting machine is realized.

Therefore, the present disclosure is a specific and effective method for evaluating the remaining life of a tool for a user's reference, solving the problem that the conventional technology cannot handle in evaluating tool life.

Although the present disclosure has been described with reference to specific embodiments, this description is not meant to be construed in a limiting sense. It should be understood that the scope of the present disclosure is not limited to the above-mentioned embodiment, but is limited by the accompanying claims. It is, therefore, contemplated that thee appended claims will cover all modifications that fall within the true scope of the present disclosure. Without departing from the object and spirit of the present disclosure, various modifications to the embodiment are possible, but they remain within the scope of the present disclosure, will be apparent to persons skilled in the art.

What is claimed is:

1. A method for estimating the tool life of a cutting machine comprising the steps of:
installing a sensor on a cutting machine for sensing the cutting thrust of a tool on the cutting machine during cutting of a workpiece;
establishing basic data by establishing different cutting rate settings for the cutting machine, and operating the cutting machine to cut the workpiece with the cutting tool according to each of the cutting rate settings, measuring the cutting thrust of the tool with the sensor at each cutting, defining the maximum cutting thrust of the tool measured at each cutting as a characteristic signal, and recording the type of the tool, the material of the workpiece, and the length of the workpiece cut at each cutting;
processing numerically the characteristic signal corresponding to each cut in the step of establishing basic data by factorization processing and inverse processing to obtain a complex value, which is defined as the complex remaining life index of the tool on the workpiece; and
processing graphically by using the cutting rate as the horizontal axis, the greater the cutting rate to the right, and using the remaining life index as the vertical axis, the greater the value to the top, the plural remaining life index and its corresponding cutting rate in step of processing numerically are plotted and connected to form a line graph according to the values of the vertical axis and the horizontal axis.

2. The tool life estimation method of claim 1, wherein in the processing numerically step, the factorization process is carried out by the following equation: The characteristic signal/length of the workpiece to be cut.

3. The tool life estimation method of claim 1, wherein in the processing numerically step, the inverse processing is performed by the following equation: 1/(the characteristic signal/the length of the workpiece being cut).

4. The tool life estimation method of claim. 1, wherein a computer performs the steps of establishing basic data, processing numerically and processing graphically.
